(19) United States
(12) Patent Application Publication
(10) Pub. No.: US 2004/0242838 A1
(43) Pub. Date: Dec. 2, 2004

(54) Sulfonated polyester and process therewith

(76) Inventor: Jiwen F. Duan, Cary, NC (US)

Correspondence Address: Jiwen F. Duan, 207 Gingergate Drive, Cary, NC, 27519, US

(21) Appl. No.: 10/453,063

(22) Filed: Jun. 2, 2003

(51) Int. Cl. C08G 63/02

(52) U.S. Cl. 528/293; 528/295

(57) ABSTRACT

A sufonic composition comprising a partially esterified and partially ester-exchanged first organic sulfonic acid and a metal salt of a second organic sulfonic acid with a glycol is disclosed. Also disclosed are a sulfopolyester containing the sulfonic composition and a process to produce such sulfopolyester, which has lower melt viscosity and better water solubility compared with a sulfopolyester containing only the commonly used sodium dimethyl 5-sulfoisophthalate.

### FIELD OF THE INVENTION

This invention relates to a sulfonated polyester copolymer containing a mixture of organic sulfonic acid and metal salt of organic sulfonic acid.

### BACKGROUND OF THE INVENTION

Metal salts of organic sulfonic acid such as sodium salt of dimethyl sulfoisophthalate (Na-SIPM) have been used commercially to produce basic dye dyeable polyethylene terephthalate (PET) fibers, as disclosed in U.S. Pat. No. 6,479,619 and U.S. patent application Ser. No. 10/187,549. Na-SIPM is widely available and inexpensive. But the PET molecules containing the sulfonic acid sodium salt tend to self associate, resulting in unusually high melt viscosity. For example, the number average molecular weight (Mw) of PET fibers containing Na-SIPM about 2% by mole is limited to about 13,000 (intrinsic viscosity IV about 0.56), which has melt viscosity about 3,000 poises at 290° C. under tube shear rate of 10 seconds⁻¹. In comparison, the Mw of regular PET textile fibers without sulfonic group is about 17,000 (IV about 0.68), which has melt viscosity about 2,700 poises at 290° C. under tube shear rate of 10 second⁻¹. The low molecular weight of sulfopolymer results in high breaks in fiber spinning.

Metal salt of organic sulfonic acid has also been used to produce polyester dispersible in water for applications such as sea-and-island fiber, biodegradable fiber, binder fiber, film, ink, coating, paint, and adhesive. U.S. Pat. No. 4,300,580 discloses a water dispersible polyester containing polyethylene glycol over 20% by mole and Na-SIPM 8% to 45% by mole. Polyester of sulfonate metal salt requires high pH and elevated temperature to be dispersible in water, thereby increasing cost and causing process difficulties.

Therefore, there is a need to develop a sulfopolyester composition, which is less likely to self-associate and, consequently, it is possible to have lower melt viscosity or higher molecular weight and less breaks during spinning. In addition, it is desirable to develop a sulfopolyester composition which is more soluble or dispersible in water.

### SUMMARY OF THE INVENTION

The invention discloses a sulfonic composition comprising, or is produced from, (a) a first organic sulfonic acid containing at least one carboxyl group or ester group, (b) a metal salt of a second organic sulfonic acid containing at least one carboxyl group or ester group, (c) a glycol. Preferably the first organic sulfonic acid and the metal salt of the second organic sulfonic acid are partially esterified or partially ester-exchanged with the glycol.

The invention also discloses a sulfopolyester comprising repeat units derived from (a) a carbonyl compound or oligomer thereof, (b) a glycol, (c) a first organic sulfonic acid containing at least one carboxyl group or ester group, (d) a metal salt of a second organic sulfonic acid containing at least one carboxyl group or ester group, (e) an ether.

Further disclosed is a process for producing the sulfopolyester comprising contacting a polymerization mixture with a sulfonic composition and optionally an ether, wherein the process is carried out under a condition effective to decrease the melt viscosity of the sulfopolyester, or to increase its water solubility. The polymerization mixture comprises a carbonyl compound or an oligomer thereof and an alkylene glycol.

### DETAILED DESCRIPTION OF THE INVENTION

The invention discloses a sulfonic composition comprising, or is produced from, (a) a first organic sulfonic acid containing at least one carboxyl group or ester group, (b) a metal salt of a second organic sulfonic acid containing at lest one carboxyl group or ester group, (c) a glycol. Preferably the first organic sulfonic acid and the metal salt of the second organic sulfonic acid are partially esterified or partially ester-exchanged with the glycol.

The first organic sulfonic acid used in the application can have the formula of RSO₃H, in which R is an organic group containing at least one carbonyl group, preferably carboxyl group or ester group. Illustrative examples of the first organic sulfonic acid include, but are not limited to, 5-sulfoisophthalic acid, sulfoterephthalic acid, sulfophthalic acid, 4-sulfophthalic acid, sulfonaphthalic acid, 4-sulfo-1,8-naphthalic anhydride, sulfosuccinic acid, 5-sulfosalicylic acid hydrate, 5-sulfosalicylic acid, 2-sulfobenzoic acid, 2-sulfobenzoic acid hydrate, 3-sulfobenzoic acid, 4-sulfobenzoic acid, dimethyl 5-sulfoisophthalate, bis(2-hydroxyethyl) 5-sulfoisophthalate, bis(3-hydroxypropyl) 5-sulfoisophthalate, bis(4-hydroxybutyl) 5-sulfoisophthalate, and ester thereof, and combinations of two or more thereof.

The metal salt of the second organic sulfonic acid used in the application can have the formula of RSO₃M, in which R is an organic group containing at least one carbonyl group, preferably carboxyl group or ester group, and M is a metal ion.

Preferably M is an alkali metal such as sodium, lithium, or potassium. Illustrative examples of the metal salt of the second organic sulfonic acid include, but are not limited to, sodium salt of 5-sulfoisophthalic acid, lithium salt of 5-sulfoisophthalic acid, potassium salt of 5-sulfoisophthalic acid, metal salt of sulfoterephthalic acid, metal salt of sulfophthalic acid, potassium salt of 4-sulfo-1,8-naphthalic anhydride, metal salt of sulfonaphthalic acid; metal salt of sulfosuccinic acid, metal salt of 5-sulfosalicylic acid, metal salt of 2-sulfobenzoic acid, sodium salt of 3-sulfobenzoic acid, potassium salt of 4-sulfobenzoic acid, sodium dimethyl 5-sulfoisophthalate, lithium dimethyl 5-sulfoisophthalate, potassium dimethyl 5-sulfoisophthalate, sodium salt of bis(2-hydroxyethyl) 5-sulfoisophthalate, lithium salt of bis(2-hydroxyethyl) 5-sulfoisophthalate, sodium salt of bis(3-hydroxypropyl) 5-sulfoisophthalate, lithium salt of bis(3-hydroxypropyl) 5-sulfoisophthalate, sodium salt of bis(4-hydroxybutyl) 5-sulfoisophthalate, lithium salt of bis(4-hydroxybutyl) 5-sulfoisophthalate, or ester thereof, and combinations of two or more thereof. The more preferred metal salts of the second organic sulfonic acid are sodium salt of 5-sulfoisophthalic acid, lithium salt of 5-sulfoisophthalic acid, and sodium dimethyl 5-sulfoisophthalate. Sodium dimethyl 5-sulfoisophthalate is the most preferred salt for its wide availability and low cost.

The carboxyl groups in the first organic sulfonic acid and the metal salt of the second organic sulfonic acid can be partially or completely esterified by a glycol. Preferably about 50% to about 99% of the carboxyl groups, more preferably about 60% to 90%, and most preferably about 70% to 80%, are esterified.

The ester groups in the first organic sulfonic acid and metal salt of the second organic sulfonic acid can be partially or completely ester-exchanged with a glycol. Preferably about 50% to about 99% of the ester groups, more preferably about 60% to 90%, and most preferably about 70% to 80%, are ester-exchanged.

The term “partially esterified or partially ester-exchanged organic sulfonic acid” refers to a first sulfonic acid or a metal salt of a second sulfonic acid in which about 50% to about 99%, preferably about 60% to 90%, and more preferably about 70% to 80%, of the carboxyl groups are esterified by a glycol, and about 50% to about 99%, preferably about 60% to 90%, and more preferably about 70% to 80%, of the ester groups are ester-exchanged with a glycol.

A first organic sulfonic acid and a metal salt of a second organic sulfonic acid can be esterified or ester-exchanged with a glycol separately. The quantity of the organic sulfonic acid can be any quantity so long as the quantity can produce a desired partially esterified or partially ester-exchanged organic sulfonic acid solution. Generally, the first organic sulfonic acid or the metal salt of the second organic sulfonic acid can be present in the range of about 1% to 70%, preferably about 5% to 50%, more preferably about 10% to 40% by weight of the solution.

Alternatively, a first organic sulfonic acid and a metal salt of a second organic sulfonic acid can be esterified or ester-exchanged together with a glycol. The quantity of each organic sulfonic acid can be any quantity so long as the quantity can produce a desired partially esterified or partially ester-exchanged organic sulfonic acid mixture. Generally, based on the total weight of the mixture, the first organic sulfonic acid can be present in the range of about 0.5% to 40%, preferably about 2% to 20%, more preferably about 5% to 10% by weight; the metal salt of the second organic sulfonic acid can be present in the range of about 5% to 70%, preferably about 10% to 50%, and more preferably about 20% to 40% by weight of the mixture.

Any glycol that can esterify or ester-exchange with the first organic sulfonic acid or metal salt of the second organic sulfonic acid can be used as the glycol of the invention. The preferred glycol has a formula HO—R—OH where R is a hydrocarbon or a hydrocarbon oxygen group containing 2 to 40 carbon atoms. Examples of suitable glycols include, but are not limited to, ethylene glycol, 1,2-propanediol, 1,3-propanediol, 1,2-butanediol, 1,3-butanediol, 1,4-butanediol, pentylene glycol, neopentyl glycol, 1,4-cyclohexanedimethanol, diethylene glycol, triethylene glycol, polyethylene glycol, polyoxyethylene glycol, polyoxypropylene glycol, polyoxybutylene glycol, alkylene glycol, dialkylene glycol, polyalkylene glycol, polyoxyalkylene glycol, and combinations of two or more thereof. The presently most preferred glycol is an alkylene glycol such as ethylene glycol or 1,3-propanediol for the polyester produced therefrom has a wide range of industrial applications.

A first organic sulfonic acid and a metal salt of a second organic sulfonic acid can be combined with a glycol in any suitable manner and in any suitable container, vessel, or reactor to produce the sulfonic composition. The mixture, generally in slurry form, can be heated at about 20° C. to 250° C., preferably about 80° C. to 200° C., and most preferably 120° C. to 180° C. for at least 5 minutes, preferably about 1 to about 10 hours to produce a solution of partially esterified or ester-exchanged mixture. Such reactions also produce vapor of water and alcohol, which along with any glycol, can be distilled and condensed in a condenser or discharged in the air, preferably condensed for environmental concerns. Thereafter, the resulting solution can be further heated at the same or lower temperature. A catalytic quantity of a catalyst such as, for example, a titanium catalyst for esterification reaction, a metal salt such as sodium acetate, lithium acetate, manganese acetate, or combinations thereof for the ester-exchange reaction can be added to the mixture.

The sulfonic composition disclosed above can be used in applications such as producing a sulfopolyester. The sulfopolyester described in this application is a class of polyester containing sulfonic groups in the polymer chains. The sulfonic groups are attached to some of the repeat units of the polymer but not all of the repeat units.

The invention also discloses a sulfopolyester comprising repeat units derived from (a) a carbonyl compound or oligomer thereof, (b) a first glycol, (c) a first organic sulfonic acid containing at least one carboxyl group or ester group, (d) a metal salt of a second organic sulfonic acid containing at least one carboxyl group or ester group, (e) an ether. The carbonyl compound is HO—R—COOH or RO₂CACO₂R; A is an alkylene group, arylene group, alkenylene group, or combinations of two or more thereof having 2 to 30 carbon atoms per group; each R is independently selected from (i) hydrogen, (ii) a hydrocarboxyl radical having a carboxylic acid group at the terminus, or (iii) a hydrocarbyl radical having 1 to 30 carbon atoms selected from an alkyl, alkenyl, aryl, alkaryl, aralkyl radical, or combinations of two or more thereof; the oligomer has 2 to 100 repeat units.

Examples of suitable carbonyl compound include, but are not limited to, terephthalic acid, isophthalic acid, phthalic acid, naphthalenedicarboxylic acid, 1,8-naphthalic anhydride, oxalic acid, malonic acid, succinic acid, glutaric acid, adipic acid, sebacic acid, maleic anhydride, maleic acid, fumaric acid, cyclohexane dicarboxylic acid, 1,2-cyclohexanedicarboxylic anhydride, dimethyl terephthalate, dimethyl isophthalate, dimethyl phthalate, dimethyl naphthalenedicarboxylate, dimethyl glutarate, dimethyl adipate, dimethyl cyclohexane dicarboxylate, lactic acid, 2-hydroxybenzoic acid, 4-hydroxybenzoic acid, mandelic acid, and combinations of two or more thereof. The presently preferred carbonyl compound are terephthalic acid and dimethyl terephthalate because the polyesters produced therefrom have a wide range of industrial applications.

Preferably the carboxyl groups or ester groups in the first organic sulfonic acid are partially esterified or partially ester exchanged with a second glycol; the carboxyl groups or ester groups in the metal salt of the second organic sulfonic acid are partially esterified or partially ester exchanged with a third glycol.

Preferably the first glycol, second glycol, and third glycol are independently an alkylene glycol. The illustrative examples of the alkylene glycol include, but are not limited to, ethylene glycol, 1,2-propanediol, 1,3-propanediol, 1,2-butanediol, 1,3-butanediol, 1,4-butanediol, pentylene glycol, neopentyl glycol, 1,4-cyclohexanedimethanol, and combinations of two or more thereof.

The first organic sulfonic acid and the metal salt of the second organic sulfonic acid are as disclosed in the above. The first organic sulfonic acid is about 0.05 to 10% by mole of the carbonyl compounds in the repeat units of the sulfopolyester, preferably 0.1% to 2%. The metal salt of second organic sulfonic acid is about 0.2 to 20% by mole of the carbonyl compounds in the repeat units of the sulfopolyester, preferably 1% to 8%.

The ether is selected from the group consisting of a dialkylene glycol such as diethylene glycol, dipropylene glycol, dibutylene glycol, and polyether such as polyethylene glycol, polypropylene glycol, polyalkylene glycol, polyoxyethylene glycol, polyoxypropylene glycol, polyoxybutylene glycol, and combinations of two or more thereof.

The sulfopolyester produced in the invention has lower melt viscosity compared with sulfopolyester containing commonly used Na-SIPM at the same molecular weight (Mw), or higher Mw at the same melt viscosity. It also has better water solubility. The sulfopolyester can be used in a variety of applications such as (i) basic dye dyeable polyester fibers, (ii) binder fibers, (iii) water soluble portion (“sea”) of the “sea-and-island” fibers, (iv) biodegradable fibers and packaging materials, (v) atmospherically dyeable fibers, (vi) films, (vii) inks, (viii) coatings, (ix) paints, and (x) adhesives.

The invention also provides a process for producing a sulfopolyester comprising contacting a polymerization mixture with a sulfonic composition and optionally an ether wherein the process is carried out under a condition effective to decrease the melt viscosity of the sulfopolyester, or to increase its water solubility. The polymerization mixture comprises a carbonyl compound or oligomer thereof as described above and an alkylene glycol.

The sulfonic composition and the ether are as described in the above. The first organic sulfonic acid is about 0.05 to 10% by mole of the carbonyl compound in the repeat units of the sulfopolyester, preferably 0.1% to 2%. The metal salt of second organic sulfonic acid is about 0.2 to 20% by mole of the carbonyl compound in the repeat units of the sulfopolyester, preferably 1% to 8%. The most preferred first organic sulfonic acid is 5-sulfoisophthalic acid or dimethyl 5-sulfoisophthalate; the most preferred metal salt of second organic sulfonic acid is sodium 5-sulfoisophthalic acid, lithium 5-sulfoisophthalic acid, sodium dimethyl 5-sulfoisophthalate, or lithium dimethyl sulfoisophthalate.

The alkylene glycol is selected from the group consisting of ethylene glycol, 1,2-propanediol, 1,3-propanediol, 1,2-butanediol, 1,3-butanediol, 1,4-butanediol, pentylene glycol, neopentyl glycol, 1,4-cyclohexanedimethanol, and combinations of two or more thereof. The most preferred alkylene glycol is a combination of ethylene glycol and neopentyl glycol, and the neopentyl glycol is 0 to about 20% by mole of the total alkylene glycol in the repeat units of the sulfopolyester.

The ether is as described in the above. While polyether is preferably added to the polymerization mixture, dialkylene glycol can be added to the polymerization mixture or generated during esterification or polycondensation, or combinations of both. Preferred ether is a combination of dialkylene glycol and polyether such as a combination of diethylene glycol (DEG) and polyethylene glycol (PEG). Dialkylene glycol can be about 0.5% to 20%, preferably 1% to 10%, by weight of the sulfopolyester. Polyether can be about 0% to about 20%, preferably 0% to 10%, by weight of the sulfopolyester.

The first organic sulfonic acid and the metal salt of the second organic sulfonic acid in the sulfonic composition can be partially or completely esterified and ester-exchanged as described in the above then added together to the polymerization mixture. Alternatively, the first organic sulfonic acid and the metal salt of the second organic sulfonic acid can be added separately to the polymerization mixture.

The contacting of the polymerization mixture with the sulfonic composition, and optionally ether, can be carried out by any suitable means. Any suitable condition to effect the production of a sulfopolyester can include a temperature in the range of from about 150° C. to about 400° C., preferably about 200° C. to about 350° C., and most preferably 250° C. to 300° C. under a pressure in the range of from about 0.001 to about 1 atmosphere for a time period of from about 0.2 to about 20, preferably about 0.3 to about 15, and most preferably 0.5 to 10 hours.

The molar ratio of the alkylene glycol to carbonyl compound can be any ratio so long as the ratio can effect the production of an ester or polyester. Generally the ratio can be in the range of from about 1:1 to about 10:1, preferably about 1:1 to about 5:1, and most preferably 1:1 to 3:1.

The polymerization can be carried out with or without a catalyst. The catalyst can be a titanium, cobalt, antimony, manganese, germanium, aluminum, silicon, zinc, or combinations thereof. A preferred catalyst is an antimony compound such as antimony oxides, antimony acetate, and antimony glycolates. The catalyst, expressed as element Ti, Co, Sb, Mn, Ge, Al, Si, Zn, or combinations thereof, can be present in the range of about 1 to about 10,000 ppm of the medium comprising the carbonyl compound and glycol, preferably about 10 to about 2,000 ppm, and most preferably 20 to 500 ppm by weight.

The polymerization can be carried out without or with a phosphorous compound. Any phosphorus compound that produces polyester having lower yellowness can be used. Examples of suitable phosphorus compounds include, but are not limited to, a phosphoric acid or salt thereof, a phosphorous acid or salt thereof, a polyphosphoric acid or a salt thereof, a pyrophosphoric acid or salt thereof, a pyrophosphorous acid or salt thereof, a phosphonate ester, di(polyoxyethylene) hydroxymethyl phosphonate, triethyl phosphonoacetate, and combinations of two or more thereof. The salt can be an alkali metal salt or an alkaline earth metal salt.

Optionally, TiO₂ or TiO₂ slurry can be added to the polymerization mixture. The polyester produced by the invention process can contain TiO₂ about 0.01% to about 5%, preferably about 0.03% to about 2.0%, based on polymer weight.

The invention process can also be carried out using conventional melt or solid state techniques and in the presence or absence of a toner compound to reduce the color of a polyester produced. Examples of toner compounds include, but are not limited to, cobalt aluminate, cobalt acetate, carbazole violet. These toner compounds are well known to those skilled in the art. The toner compound can be used in the amount of about 0.1 ppm to 1000 ppm, preferably about 1 ppm to 100 ppm, based on the weight of polyester polymer produced.

The process of the invention can also be carried out using a conventional melt or solid state technique and in the presence or absence of an optical brightening compound to reduce the yellowness of the polyester produced. Examples of optical brightening compounds include, but are not limited to, 7-naphthotriazinyl-3-phenylcoumarin and 4,4′-bis(2-benzoxazolyl)stilbene. These optical brightening compounds are well known to those skilled in the art. The optical brightening compound can be used in the amount of about 0.1 ppm to 1,000 ppm, preferably about 1 ppm to 1100 ppm, based on the weight of polyester polymer produced.

### EXAMPLES

The following examples are included to further illustrate the invention and are not to be construed as to unduly limit the scope of the invention.

Polymer molecular weight is measured by intrinsic viscosity (IV). The IV is analyzed by the ratio of the viscosity of a solution of 0.8 g of polymer dissolved in 10 ml of hexafluoroisopropanol (HFIP) containing 100 ppm sulfuric acid to the viscosity of the sulfuric acid containing HFIP itself, at 25° C. in a capillary viscometer.

Diethylene glycol (DEG) in polymer is analyzed by depolymerization. The samples are treated with 2-aminoethanol (2AE) containing benzyl alcohol (BA) as an internal standard. The reaction mixture is diluted with isopropyl alcohol and injected into a gas chromatograph. The ratio of the areas of the DEG and BA peaks, corrected for the sample weight, is translated by a calibration factor into weight percent DEG.

### Example 1

This example illustrates the preparation of a solution of partially ester-exchanged Na-SIPM solution and partially esterified sulfosuccinic acid in glycol.

Ethylene glycol (EG; 1263 g), dimethyl sodium 5-sulfoisophthalate (Na-SIPM; 400 g; from Aldrich, Milwaukee, Wis., USA), and magnesium acetate tetrahydrate (1 g, from Aldrich) are added to a 2500-ml flask to produce a slurry. The slurry is stirred with a magnet stirrer and heated under a hood. The ester-exchange byproduct methanol is evaporated during heating. When the slurry is heated to 160° C. it becomes a clear solution. The solution is kept at 160° C. until the total weight decreases by 64 g. Then 1600 g of partially ester-exchanged Na-SIPM solution is cooled to room temperature.

Sulfosuccinic acid (40 g, 70% in water, from Aldrich) is added to 800 g of the partially ester exchanged Na-SIPM solution prepared in the above. The mixture is agitated and heated to 160° C. under a hood. Water is evaporated during heating. When the total weight decreases by 16 g, the partially ester exchanged and partially esterified organic sulfonic acid solution is cooled to room temperature.

### Example 2

This example illustrates that sulfopolyester containing the mixture of organic sulfonic acid and metal salt of organic sulfonic acid has higher molecular weight at the same melt viscosity (therefore lower melt viscosity at the same molecular weight) compared with sulfopolyester containing only the metal salt of organic sulfonic acid.

An oligomer of polyethylene terephthalate (PET) with a degree of polymerization between 5 and 10 is obtained from a continuous esterification process. Terephthalic acid is esterified by ethylene glycol to form the oligomer in an esterifier. The polyester esterification and polycondensation process are well known to one skilled in the art, only a brief description is provided herein.

A pot is preheated to 265° C. A 500-ml resin kettle is provided with an agitator, a thermocouple, condenser and nitrogen sweep. To this kettle it is added 75 g of ethylene glycol, 388 g of oligomer, 48 g of partially ester-exchanged Na-SIPM solution prepared in EXAMPLE 1, 0.24 g of sodium acetate anhydrous, 6 g of TiO₂ 20% slurry in ethylene glycol and 4 g of antimony glycolate solution (containing 1% Sb by weight). The temperature is increased to 265° C. and held there until oligomer is liquefied, the agitator is turned on at 60 rpm. Temperature is raised to 275° C. and vacuum reduced to 120 mm Hg (16 kPa) and held for 20 minutes. The temperature is then increased to 280° C. and vacuum reduced to 30 mm Hg (4 kPa) and hold for 20 minutes. Thereafter, the vacuum is reduced to 1 mm Hg (0.133 kPa) while temperature is held at 285° C. When the torque reaches 3 kg, agitator speed is reduced to 40 rpm. Polymerization stops when the torque reaches 4 kg at 40 rpm. The polymer melt is poured into a water bath to solidify the melt, and the resultant solid is crystallized at 90° C. in a vacuum oven for 1 hour and ground to pass a 2-mm filter. The grounded polymer is dried in the oven at 90° C. for another hour. The polymer is analyzed for molecular weight, IV about 0.55, and DEG about 2% by weight.

The sulfopolyester containing a mixture of organic sulfonic acid and metal salt of organic sulfonic acid is prepared similarly as the above, with 41 g of partially ester exchanged and partially esterified Na-SIPM and sulfosuccinic acid mixture solution prepared in EXAMPLE 1 added instead of 48 g of partially ester exchanged Na-SIPM solution. Polymerization stops at the same torque (therefore similar melt viscosity), the polymer has IV about 0.6 and DEG about 3% by weight.

### Example 3

This example illustrates that sulfopolyester containing the mixture of organic sulfonic acid and metal salt of organic sulfonic acid has higher solubility in water compared with sulfopolyester containing only the metal salt of organic sulfonic acid.

A 500-ml resin kettle is set up the same as that in EXAMPLE 2. To this kettle it is added 27 g of ethylene glycol, 370 g of oligomer prepared in EXAMPLE 2, 120 g of partially ester exchanged Na-SIPM solution prepared in EXAMPLE 1, 20 g of polyethylene glycol (average Mw 400, from Aldrich). Polymerization procedures are the same as those in EXAMPLE 2. The polymer melt is poured into aluminum pots, and the resultant solid is dried in vacuum oven without heat for 1 hour and ground to pass through a 2-mm filter. The grounded polymer is analyzed for molecular weight, the IV is about 0.55 ml/g at this torque, and DEG is about 6% by weight. 5 grams of the grounded polymer is dissolved in 100 grams of hot water containing NaOH 1% at 95° C. in 2 hours.

The sulfopolyester containing a mixture of organic sulfonic acid and metal salt of organic sulfonic acid is prepared similarly as the above, with 102 g of partially ester exchanged and partially esterified Na-SIPM and sulfosuccinic acid mixture solution prepared in EXAMPLE 1 and 46 g of ethylene glycol added instead of 120 g of partially ester exchanged Na-SIPM solution and 27 g of ethylene glycol. Polymerization stops at the same torque (therefore similar melt viscosity), the polymer has IV about 0.6 and DEG about 10%. Five (5) g of the grounded polymer is dissolved in 100 g of hot water containing NaOH 1% at 95° C. in half an hour.

1. A sulfonic composition comprising, or is produced from, (a) a first organic sulfonic acid containing at least one carboxyl group or ester group, (b) a metal salt of a second organic sulfonic acid containing at least one carboxyl group or ester group, (c) a glycol, wherein said first organic sulfonic acid and said second organic sulfonic acid are partially esterified or partially ester-exchanged with said glycol.

2. A composition according to claim 1 wherein about 50% to about 99% of said carboxyl groups in said first organic sulfonic acid and said second organic sulfonic acid are esterified by said glycol, and about 50% to about 99% of said ester groups in said first organic sulfonic acid and said second organic sulfonic acid are ester-exchanged with said glycol.

3. A composition according to claim 2 wherein about 60% to about 90% of said carboxyl groups and said ester groups in said first organic sulfonic acid and said second organic sulfonic acid are esterified by said glycol or ester exchanged with said glycol.

4. A composition according to claim 3 wherein said first organic sulfonic acid is 5-sulfoisophthalic acid, sulfoterephthalic acid, sulfophthalic acid, 4-sulfo-1,8-naphthalic anhydride, sulfonaphthalic acid, sulfosuccinic acid, 5-sulfosalicylic acid, sulfobenzoic acid, dimethyl 5-sulfoisophthalate, or ester thereof, or combinations of two or more thereof.

5. A composition according to claim 4 wherein said metal salt of second sulfonic organic acid is sodium salt of 5-sulfoisophthalic acid, lithium salt of 5-sulfoisophthalic acid, potassium salt of 5-sulfoisophthalic acid, metal salt of sulfoterephthalic acid, metal salt of sulfophthalic acid, metal salt of 4-sulfo-1,8-naphthalic anhydride, metal salt of sulfonaphthalic acid, metal salt of sulfosuccinic acid, metal salt of 5-sulfosalicylic acid, metal salt of sulfobenzoic acid, sodium dimethyl 5-sulfoisophthalate, lithium dimethyl 5-sulfoisophthalate, potassium dimethyl 5-sulfoisophthalate, or ester thereof, or combinations of two or more thereof.

6. A composition according to claim 5 wherein said glycol has a formula HO—R—OH wherein R is a hydrocarbon or a hydrocarbon oxygen group containing 2 to 40 carbon atoms.

7. A composition according to claim 6 wherein said first organic sulfonic acid is about 0.5% to about 40%, and said metal salt of said second organic sulfonic acid is about 5% to about 70%, based on the weight of said sulfonic composition.

8. A process for producing a sulfopolyester comprising contacting a polymerization mixture with a sulfonic composition and optionally an ether wherein
said process is carried out under a condition effective to decrease the melt viscosity of said sulfopolyester, or to increase the water solubility of said sulfopolyester;
said sulfonic composition comprises (a) a first organic sulfonic acid containing at least one carboxyl group or ester group and (b) a metal salt of a second organic sulfonic acid containing at least one carboxyl group or ester group;
said polymerization mixture comprises a carbonyl compound or oligomer thereof and an alkylene glycol;
said carbonyl compound is HO—R—COOH or RO₂CACO₂R;
A is an alkylene group, arylene group, alkenylene group, or combinations of two or more thereof having 2 to 30 carbon atoms per group;
each R is independently selected from (i) hydrogen, (ii) a hydrocarboxyl radical having a carboxylic acid group at the terminus, or (iii) a hydrocarbyl radical having 1 to 30 carbon atoms selected from an alkyl, alkenyl, aryl, alkaryl, aralkyl radical, or combinations of two or more thereof;
said oligomer has 2 to 100 repeat units.

9. A process according to claim 8 wherein said first sulfonic organic acid is partially esterified or partially ester-exchanged with said alkylene glycol, and said metal salt of said second sulfonic organic acid is partially esterified or partially ester exchanged with said alkylene glycol.

10. A process according to claim 9 wherein said first organic sulfonic acid is about 0.05% to about 10% by mole of said carbonyl compounds; and said first organic sulfonic acid is 5-sulfoisophthalic acid, sulfoterephthalic acid, sulfophthalic acid, 4-sulfo-1,8-naphthalic anhydride, sulfonaphthalic acid, sulfosuccinic acid, 5-sulfosalicylic acid, sulfobenzoic acid, dimethyl 5-sulfoisophthalate, bis(2-hydroxyethyl) 5-sulfoisophthalate, bis(3-hydroxypropyl) 5-sulfoisophthalate, bis(4-hydroxybutyl) 5-sulfoisophthalate, or ester thereof, or combinations of two or more thereof.

11. A process according to claim 10 wherein said second organic sulfonic acid is 0.2 to 20% by mole of said carbonyl compounds; and said metal salt of second sulfonic organic acid is sodium salt of 5-sulfoisophthalic acid, lithium salt of 5-sulfoisophthalic acid, potassium salt of 5-sulfoisophthalic acid, metal salt of sulfoterephthalic acid, metal salt of sulfophthalic acid, metal salt of 4-sulfo-1,8-naphthalic anhydride, metal salt of sulfonaphthalic acid, metal salt of sulfosuccinic acid, metal salt of 5-sulfosalicylic acid, metal salt of sulfobenzoic acid, sodium salt of dimethyl 5-sulfoisophthalate, lithium salt of dimethyl 5-sulfoisophthalate, potassium salt of dimethyl 5-sulfoisophthalate, sodium salt of bis(2-hydroxyethyl) 5-sulfoisophthalate, lithium salt of bis(2-hydroxyethyl) 5-sulfoisophthalate, metal salt of bis(3-hydroxypropyl) 5-sulfoisophthalate, metal salt of bis(4-hydroxybutyl) 5-sulfoisophthalate, or ester thereof, or combinations of two or more thereof.

12. A process according to claim 11 wherein said first organic sulfonic acid is 5-sulfoisophthalic acid or dimethyl 5-sulfoisophthalate; said metal salt of second organic sulfonic acid is sodium 5-sulfoisophthalic acid, lithium 5-sulfoisophthalic acid, sodium dimethyl 5-sulfoisophthalate, or lithium dimethyl sulfoisophthalate.

13. A process according to claim 11 wherein said alkylene glycol is selected from the group consisting of ethylene glycol, 1,2-propanediol, 1,3-propanediol, 1,2-butanediol, 1,3-butanediol, 1,4-butanediol, pentylene glycol, neopentyl glycol, 1,4-cyclohexanedimethanol, and combinations of two or more thereof.

14. A process according to claim 13 wherein said alkylene glycol is a combination of ethylene glycol and neopentyl glycol; and said neopentyl glycol is 0 to about 20% by mole of said alkylene glycol in the repeat units of said sulfopolyester.

15. A process according to claim 13 wherein said ether is selected from the group consisting of diethylene glycol, triethylene glycol, dipropylene glycol, dibutylene glycol, polyethylene glycol, polypropylene glycol, polyoxyethylene glycol, polyoxypropylene glycol, polyoxybutylene glycol, and combinations of two or more thereof.

16. A process according to claim 15 wherein said ether is a combination of diethylene glycol and polyethylene glycol.

17. A sulfopolyester comprising repeat units derived from (a) a carbonyl compound or oligomer thereof, (b) a first glycol, (c) a first organic sulfonic acid containing at least one carboxyl group or ester group, (d) a metal salt of a second organic sulfonic acid containing at least one carboxyl group or ester group, (e) an ether, wherein
said carbonyl compound is HO—R—COOH or RO₂CACO₂R;
A is an alkylene group, arylene group, alkenylene group, or combinations of two or more thereof having 2 to 30 carbon atoms per group;
each R is independently selected from (i) hydrogen, (ii) a hydrocarboxyl radical having a carboxylic acid group at the terminus, or (iii) a hydrocarbyl radical having 1 to 30 carbon atoms selected from an alkyl, alkenyl, aryl, alkaryl, aralkyl radical, or combinations of two or more thereof;
said oligomer has 2 to 100 repeat units;
said carboxyl group or ester group in said first organic sulfonic acid is partially esterified or partially ester changed with a second glycol; and
said carboxyl group or ester group in said metal salt of said second organic sulfonic acid is partially esterified or partially ester exchanged with a third glycol.

18. A composition according to claim 17 wherein said first glycol, said second glycol, and said third glycol are independently selected from the group consisting of ethylene glycol, 1,2-propanediol, 1,3-propanediol, 1,2-butanediol, 1,3-butanediol, 1,4-butanediol, pentylene glycol, neopentyl glycol, 1,4-cyclohexanedimethanol, and combinations of two or more thereof.

19. A composition according to claim 18 wherein said first organic sulfonic acid and said second organic sulfonic acid are each independently selected from the group consisting of 5-sulfoisophthalic acid, sulfoterephthalic acid, 4-sulfophthalic acid, 4-sulfo-1,8-naphthalic anhydride, sulfonaphthalic acid, sulfosuccinic acid, 5-sulfosalicylic acid, 2-sulfobenzoic acid, 3-sulfobenzoic acid, 4-sulfobenzoic acid, dimethyl 5-sulfoisophthalate, bis(2-hydroxyethyl) 5-sulfoisophthalate, bis(3-hydroxypropyl) 5-sulfoisophthalate, bis(4-hydroxybutyl) 5-sulfoisophthalate, ester thereof, and combinations of two or more thereof.

20. A composition according to claim 19 wherein said ether is selected from the group consisting of diethylene glycol, triethylene glycol, dipropylene glycol, dibutylene glycol, polyethylene glycol, polypropylene glycol, polyoxyethylene glycol, polyoxypropylene glycol, polyoxybutylene glycol, and combinations of two or more thereof.
